(19) United States
(12) Patent Application Publication
(10) Pub. No.: US 2026/0322725 A1
(43) Pub. Date: Oct. 15, 2026

(54) DYNAMIC NETWORK MANAGEMENT OF DNS SRV RECORD PRIORITIES

(71) Applicant: VERIZON PATENT AND LICENSING INC., Basking Ridge, NJ (US)

(72) Inventors: Khalid ADNAN, Lincroft, NJ (US); Carlos J. TORRES, East Brunswick, NJ (US); Peter B. SENSENBRENNER, North Richland Hills, TX (US); Ryan T. RODRIGUEZ, Manville, NJ (US)

(73) Assignee: VERIZON PATENT AND LICENSING INC., Basking Ridge, NJ (US)

(21) Appl. No.: 19/175,354

(22) Filed: Apr. 10, 2025

(51) Int. Cl. H04L 43/0882; H04L 43/0805

(52) U.S. Cl. CPC H04L 43/0882; H04L 43/0805

(57) ABSTRACT

In some implementations, the techniques described herein relate to a method including: monitoring, by a processor, a plurality of SRV targets referenced in SRV records to determine availability status; performing, by the processor, health checks on each of the plurality of SRV targets using protocol information specified in the SRV records; determining, by the processor, whether each of the plurality of SRV targets is reachable based on responses to the health checks; adjusting, by the processor, priority values in the SRV records, the priority values for unreachable targets set to a lower preference level than priority values for reachable targets; and updating, by the processor, the SRV records in an authoritative DNS server with the priority values.

### BACKGROUND

Domain Name System (DNS) Service (SRV) records provide a mechanism for clients to locate network services by mapping service names to the servers that host them. When a client requests SRV records for a particular service, the DNS server returns a list of available targets along with their associated priority and weight values. Clients use these priority values to determine the order in which to attempt connections, starting with the target having the lowest numerical priority value (highest preference).

### BRIEF DESCRIPTION OF THE DRAWINGS

FIG. 1 is a block diagram illustrating a dynamic DNS service record management system according to some embodiments of the disclosure.

FIG. 2 is a sequence diagram illustrating the operational flow of the dynamic DNS service record management system according to some embodiments of the disclosure.

FIG. 3 is a flowchart illustrating a method for performing health checks and dynamically updating SRV record priorities or weights according to some embodiments of the disclosure.

FIG. 4 is a flowchart illustrating an enhanced load-based health check process for updating SRV priorities or weights according to some embodiments of the disclosure.

FIG. 5 is a block diagram of a computing device according to some embodiments of the disclosure.

### DETAILED DESCRIPTION

In conventional DNS implementations, SRV record priorities are statically configured and do not change unless manually updated by an administrator. When a client obtains SRV records, it selects targets based on these static priority values without any knowledge of whether the targets are reachable. If a high-priority target becomes unavailable, clients must attempt and fail to connect to it before trying the next target in the list. This process can cause significant delays in establishing connections, especially in environments where service targets can experience intermittent failures or network issues.

Additionally, as network services scale and traffic increases, the static nature of conventional SRV priority assignments becomes increasingly problematic. Without dynamic adjustments based on current operational conditions, clients can continue to be directed to overloaded or underperforming servers even when better alternatives are available. This limitation can lead to suboptimal resource utilization, inconsistent service quality, and poor user experience.

Current SRV record implementations lack a mechanism to dynamically reflect the actual availability status of service targets. When a client queries DNS for SRV records, it receives a list of targets with static priorities that do not account for targets that can be unreachable or experiencing performance degradation. This technical limitation forces clients to attempt connections to targets in strict priority order, regardless of their operational state. When higher-priority targets become unavailable, clients must experience connection timeouts before attempting alternative targets, introducing significant latency in service establishment. This inefficiency is compounded across multiple clients, as each must independently discover the same unreachable targets through failed connection attempts, wasting network resources and degrading user experience.

The disclosed embodiments solve this, and other, technical problems by implementing a health check server that actively monitors the reachability of SRV targets using the protocol information already present in the SRV records. When the health check server detects that a target is unreachable, it dynamically updates the priority field in the corresponding SRV record to a very high numerical value (e.g., 65535), effectively placing it at the lowest preference level. When the target becomes reachable again, the health check server restores its original priority value. This technical approach leverages the existing SRV record format and DNS update protocols to create a transparent solution that requires no modifications to clients or to the DNS protocol itself. By operating at regular intervals tied to the Time to Live (TTL) of the SRV records, the system ensures that clients receive up-to-date information about target availability without requiring any awareness of the health monitoring system, thereby eliminating connection delays caused by unreachable targets. In some implementations, the system can additionally consider the load on a given SRV target to adjust priorities or weights even when an SRV is reachable.

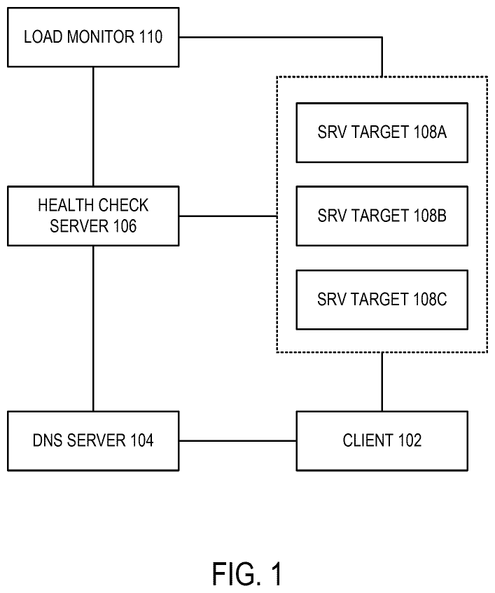

FIG. 1 is a block diagram illustrating a dynamic DNS service record management system according to some embodiments of the disclosure.

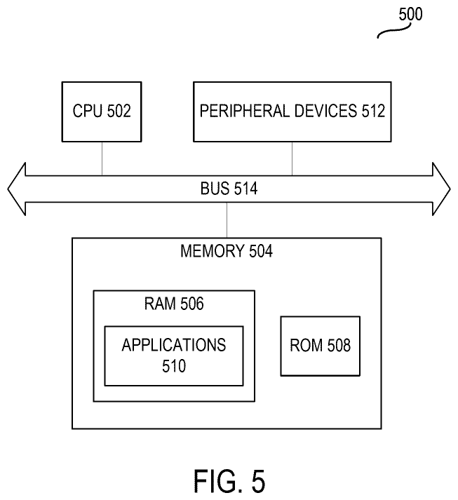

In the illustrated embodiment, the system includes a client 102, a DNS server 104, a health check server 106, a plurality of SRV targets (SRV Target 108A, SRV Target 108B, SRV Target 108C), and a load monitor 110. Each of these components can be implemented using general-purpose computing devices as described in FIG. 5, with specific configurations according to their respective roles within the system architecture.

Client 102 can represent any networked computing device configured to interact with services provided by SRV targets (SRV Target 108A, SRV Target 108B, SRV Target 108C). As illustrated, client 102 can perform standard DNS operations including requesting SRV records from DNS server 104 and selecting SRV targets based on priority and weight values contained in those records. The client 102 can use these priority values to determine which SRV target to contact first, attempting connections to targets in order of their assigned priority. This standard behavior is used to direct clients to optimal service targets without requiring modifications to the clients themselves. By working within the existing DNS protocol framework, the system can maintain backward compatibility with standard DNS clients.

DNS server 104 can comprise an authoritative DNS server responsible for maintaining and providing DNS records, including SRV records, to clients. The DNS server 104 can store SRV records that include information about services available on the network, including their host names, port numbers, priorities, and weights. When client 102 requests SRV records for a particular service, DNS server 104 can respond with the current SRV records. In some implementations, DNS server 104 can include an interface allowing the health check server 106 to dynamically update the priority values of SRV records, enabling the core functionality of the present system. This update capability can utilize standard DNS update protocols, allowing the system to work with existing DNS server implementations without requiring specialized modifications.

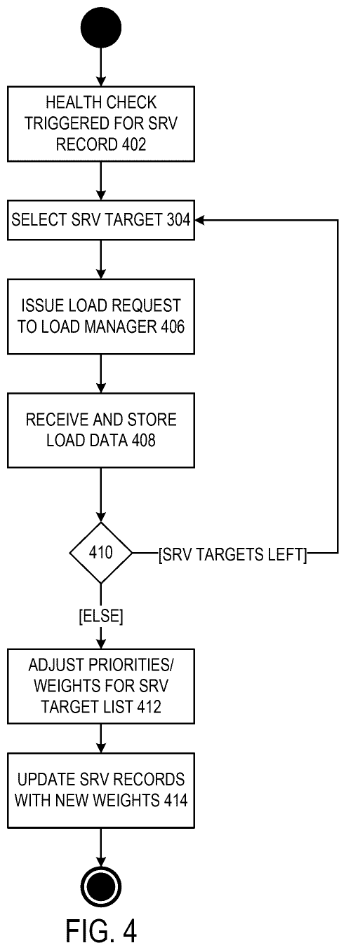

SRV targets (SRV Target 108A, SRV Target 108B, SRV Target 108C) can comprise server devices configured to provide particular network services to clients. These targets are referenced in SRV records maintained by DNS server 104, allowing clients to locate and connect to them. In standard DNS implementations, these targets would have static priority values, potentially causing clients to attempt connections to unavailable targets before finding an operational one. This inefficiency is addressed by the dynamic priority adjustment mechanism provided by the present system. In the enhanced load monitoring embodiment illustrated in FIG. 4, these targets can include additional functionality to report load metrics or other performance indicators to the load monitor 110, enabling even more service targeting.

Health check server 106 can actively monitor the health status of SRV targets (SRV Target 108A, SRV Target 108B, SRV Target 108C) and dynamically adjust their corresponding priority values in the DNS server's SRV records. The health check server 106 can perform several functions that work together to provide the system's primary benefits.

First, the health check server 106 can proactively test the availability of each SRV target by sending connectivity checks based on the protocol and port information specified in the SRV records. These checks can be performed periodically, typically at a frequency determined by the TTL values of the SRV records, such as half the TTL time. This can ensure that health status updates occur frequently enough to maintain accurate service targeting without creating excessive network traffic. These checks can be connectivity tests in one implementation or more load-based assessments in alternative implementations, both described in detail later herein.

Second, the health check server 106 can maintain an internal state representation of all SRV targets, essentially creating a dynamically sorted list that ranks targets according to their availability or responsiveness. This state information can allow the system to track the health history of targets and make intelligent decisions about priority adjustments. In a first implementation, this can result in a bipartite list with healthy servers grouped separately from unhealthy ones. In the load-based embodiment, this ranking can follow a more continuous spectrum based on performance metrics, allowing for finer-grained priority assignments.

Third, based on this internal state, the health check server 106 can calculate appropriate priority values for each SRV target. Unhealthy or heavily loaded targets can receive numerically higher priority values (e.g., 65535), effectively positioning them at the lowest priority level, while healthy targets can maintain their original lower priority values indicating higher preference. This priority adjustment mechanism can thus direct clients away from problematic targets without requiring client-side changes.

Fourth, the health check server 106 can issue update requests to DNS server 104 to modify the SRV records with these recalculated priority values. This operation can occur periodically, typically at a frequency aligned with the health check operations, to ensure changes propagate in a timely manner. When the DNS server receives these updates, it can modify the stored SRV records accordingly, ensuring that subsequent client requests receive the updated priority information.

In some implementations, health check server 106 can maintain a default listing of SRV targets with their original priority values, allowing it to restore targets to their default priorities when they return to a healthy state after a period of unavailability. This restoration capability can ensure that the system can return to its intended service hierarchy once all targets are operational, maintaining the original service design while providing resilience against temporary outages.

The health check server 106 can utilize various configurable parameters to fine-tune its operation, including the frequency of health checks, the number of retry attempts before marking a target as unhealthy, the priority values assigned to unhealthy targets, and the conditions under which a target is considered to have recovered. These configuration options can allow the system to be adapted to diverse deployment scenarios with different reliability requirements and network characteristics.

In some implementations, load monitor 110 can be utilized to enable more service targeting based on performance metrics rather than only availability or reachability. This component can periodically collect load and performance data from SRV targets (SRV Target 108A, SRV Target 108B, SRV Target 108C) and aggregate this information to provide a comprehensive view of target performance across the system. The load monitor 110 can collect various metrics including CPU utilization, memory usage, network bandwidth consumption, request latency, or application-specific performance indicators, depending on the specific requirements of the deployed services.

The load monitor 110 can provide an endpoint that the health check server 106 can query to obtain current load information. This architecture can allow the health check server 106 to adjust SRV priorities based on both connectivity and performance considerations, directing clients away from not only unavailable targets but also those experiencing high load or performance degradation. By incorporating load information into the priority calculation process, the system can implement load balancing strategies within the constraints of the standard SRV record format.

In some implementations, the load monitoring functionality can be combined with the basic connectivity checks, using a progressive approach that first verifies basic reachability and then incorporates performance considerations for targets that pass the initial connectivity check. This layered approach can ensure that unreachable targets are immediately deprioritized regardless of their reported performance metrics, while simultaneously allowing for fine-grained prioritization among the remaining reachable targets based on their current load levels.

In operation, client 102 can follow standard DNS procedures by requesting SRV records from DNS server 104 and selecting targets based on the priority values in those records. Meanwhile, health check server 106 can continuously monitor the availability and, optionally, the performance of SRV targets (SRV Target 108A, SRV Target 108B, SRV Target 108C) and updates their priorities in DNS server 104 accordingly.

When a target becomes unreachable, health check server 106 can detect this condition through its periodic connectivity checks and updates its priority to a very high value (e.g., 65535), effectively relegating it to the lowest priority position. Subsequent client requests for SRV records can receive these updated priorities, causing clients to attempt connections to the remaining healthy targets first. This automatic redirection can occur transparently to the clients, requiring no client-side awareness of the health monitoring system.

Upon detecting that a previously unreachable target has become available again, health check server 106 can restore its original priority value, allowing it to resume its intended role in the service hierarchy. This restoration process can ensure that the system can recover its original configuration after temporary outages or maintenance periods, maintaining the intended service design while providing resilience against transient failures.

In the enhanced embodiment, load monitor 110 can collect performance metrics from SRV targets (SRV Target 108A, SRV Target 108B, SRV Target 108C) and provides this data to health check server 106. The health check server can then use this information to further refine priority assignments, adjusting values based on both availability and performance considerations. This refinement can allow the system to implement load distribution strategies while remaining fully compatible with standard DNS clients.

This dynamic priority adjustment mechanism can allow for efficient client connections without requiring modifications to either clients or the DNS protocol itself. By using the existing priority field in SRV records, the system can transparently direct clients to optimal service targets while maintaining compatibility with standard DNS implementations. The system thus provides a non-intrusive solution to the problem of unreachable or overloaded service targets, improving client experience without requiring widespread client-side updates or protocol modifications.

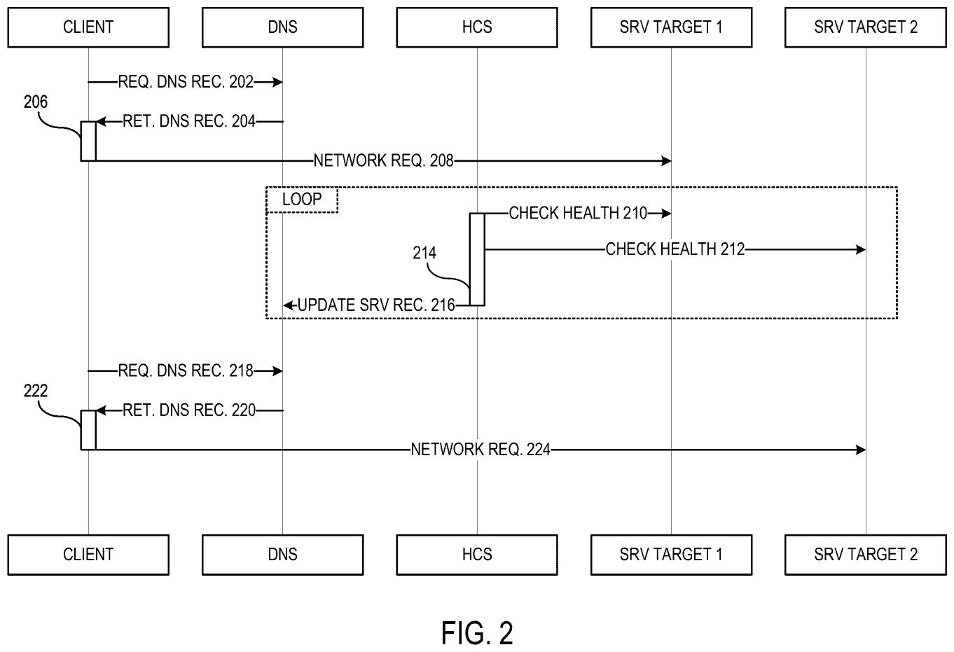

FIG. 2 is a sequence diagram illustrating the operational flow of the dynamic DNS service record management system according to some embodiments of the disclosure.

In the illustrated embodiment, the sequence diagram includes five main participants: a client, a DNS server, a health check server (HCS), SRV target 1, and SRV target 2. The diagram is organized to show three primary operational sequences: the normal DNS flow, the periodic health check process, and the updated DNS flow that results from health-based priority adjustments. These sequences illustrate how the system maintains backward compatibility with standard DNS clients while providing enhanced service reliability through dynamic SRV record management.

The sequence begins with the normal DNS flow, which represents the standard operation of DNS-based service discovery without any health-based enhancements. In step 202, the client can send a request to the DNS server for SRV records associated with a particular service. This request can follow the standard DNS protocol and contains the domain name for which the client is seeking service information.

In step 204, the DNS server can respond to the client's request by returning the current SRV records for the requested service. These records can include information about available service targets, including their host names, port numbers, and their priority and weight values. At this point, the DNS server's active phase can end, having fulfilled its role in the standard DNS resolution process.

Following the receipt of SRV records, the client can perform step 206, in which it processes the received SRV records to select the optimal target for connection. This selection is typically based on the priority values contained in the SRV records, with lower numerical values indicating higher priority. In standard DNS implementations, clients can attempt to connect to the highest-priority target first (i.e., the lowest numerical priority value), falling back to lower-priority targets only if connection attempts to higher-priority targets fail.

Having selected the optimal target based on the received priority values, in step 208, the client can initiate a network request to SRV target 1, which in this initial example represents the highest-priority target according to the current SRV records. This network request typically uses the protocol and port information specified in the SRV records to establish a connection to the selected target.

The sequence diagram then transitions to the periodic health check process. This process is depicted as a loop, indicating that it can occur repeatedly at regular intervals, independent of client activity. In typical implementations, this loop can execute at a frequency determined by the TTL values of the SRV records, such as half the TTL time, ensuring that health information remains current without creating excessive network traffic.

At the start of each health check cycle, the health check server becomes active. In step 210, the health check server initiates a connectivity check to SRV target 1. This check typically involves sending a network request using the protocol and port information specified in the SRV records for that target. The purpose of this request is to determine whether the target is reachable and capable of responding to client requests.

Similarly, in step 212, the health check server performs a connectivity check on SRV target 2, following the same process used for SRV target 1. Although the diagram illustrates checks for only two targets, in practical implementations, this process would be repeated for all SRV targets associated with the service being monitored, regardless of their current priority values.

In step 214, after receiving responses (or timeouts) from monitored SRV targets, the health check server can update its internal representation of target health states. This internal state typically can categorize targets as either reachable or unreachable in the one implementation, although more implementations can incorporate additional metrics such as response time or load information to create a more nuanced ranking of target suitability.

Based on the updated health state information, in step 216, the health check server can issue a request to the DNS server to update the priority values in the SRV records. In this update operation, the priority values of unreachable targets can be set to very high numerical values (e.g., 65535), effectively positioning them at the lowest priority level. Conversely, reachable targets can maintain their original lower priority values, ensuring they remain the preferred connection targets for clients.

The sequence diagram then illustrates the updated DNS flow, which demonstrates how the health-based priority adjustments affect subsequent client connections. This sequence begins with step 218, in which the client can issue another request to the DNS server for SRV records associated with the service. This request can be identical to the one in step 202, following the standard DNS protocol without any special awareness of the health check system.

In step 220, the DNS server can respond to the client's request by returning the current SRV records for the requested service. However, unlike in step 204, these records now contain the updated priority values that reflect the current health state of the targets as determined by the health check server.

Following the receipt of the updated SRV records, the client becomes active again and can perform step 222, in which it processes the received records to select the optimal target for connection. This selection process is identical to that in step 206, using the standard DNS priority-based selection mechanism without any modifications. However, because the priority values in the received records now reflect the current health state of the targets, this standard selection process naturally directs the client to healthy targets.

In step 224, having selected the optimal target based on the updated priority values, the client can initiate a network request to SRV target 2. This differs from the initial flow, where the client connected to SRV target 1, illustrating how the health-based priority adjustments have redirected the client to a different target. This redirection occurs transparently to the client, requiring no client-side awareness of the health monitoring system. Following this connection attempt, the client's active phase ends.

In contrast to existing DNS solutions, the system provides the ability to redirect clients to healthy service targets without requiring any modifications to the clients themselves or to the DNS protocol. By dynamically adjusting the priority values in the SRV records based on target health, the system leverages the existing priority-based selection mechanism built into standard DNS clients to achieve automatic failover and load distribution.

This approach offers several significant advantages over traditional methods of service reliability enhancement. First, it operates entirely on the server side, eliminating the need for client updates or protocol modifications, thus ensuring compatibility with the entire existing base of DNS clients. Second, it provides immediate redirection upon target failure, as opposed to traditional approaches where clients must attempt and fail at connections to unreachable targets before falling back to alternatives. Third, it allows for seamless recovery when previously unreachable targets become available again, as the health check process will detect this change and restore the original priority values.

Furthermore, the periodic nature of the health check process ensures that the system maintains an up-to-date view of target health, allowing it to respond rapidly to changes in target availability or performance. This responsiveness is critical in dynamic network environments where service targets can experience transient failures or varying load conditions.

In more implementations, the health check process depicted in this sequence diagram can incorporate additional metrics beyond simple reachability, such as response time, load levels, or application-specific performance indicators. By considering these additional factors when adjusting priority values, the system can provide more nuanced service targeting, directing clients not just to reachable targets but to those offering optimal performance under current conditions.

Overall, FIG. 2 illustrates how the present disclosure provides a robust solution to the challenge of service reliability in DNS-based systems, enabling automatic failover and load distribution while maintaining full compatibility with existing DNS clients and protocols. The sequence diagram demonstrates how the health check process interacts with standard DNS operations to create a seamless, transparent enhancement to service reliability without requiring client-side modifications.

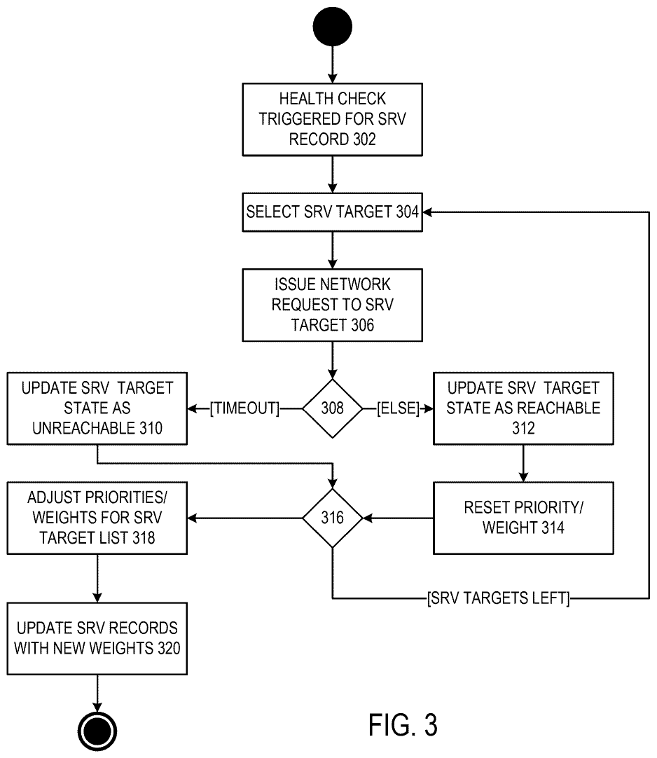

FIG. 3 is a flowchart illustrating a method for performing health checks and dynamically updating SRV record priorities or weights according to some embodiments of the disclosure.

In step 302, the method triggers a health check cycle for a specific SRV record. This triggering typically occurs at regular intervals defined relative to the TTL value of the SRV records being monitored, such as at half the TTL time. This periodic execution ensures that the method maintains current information about target health without creating excessive network traffic or processing load. In some implementations, the method can also trigger health checks based on external events, such as notifications from monitoring systems or manual administrative commands, allowing for immediate response to known service disruptions.

Following the initiation of the health check cycle, the method proceeds to step 304, where the method selects a specific SRV target for health assessment. This selection is typically performed sequentially, processing each target associated with the SRV record being monitored. The selection operation maintains a reference to the current target being checked and retrieves the necessary connection information, including the hostname, port, and protocol specifications from the corresponding SRV record.

After selecting a target, the method proceeds to step 306, where the method issues a network request to the selected SRV target. This request is constructed using the protocol information specified in the SRV record, ensuring that the health check accurately represents the connection type that would be used by actual clients. For example, if the SRV record specifies a TCP-based service, the method would attempt to establish a TCP connection to the target using the specified port number. Similarly, for UDP-based services, the method would send a UDP datagram and await a response. This protocol-specific approach ensures that the health assessment accurately reflects the actual availability of the service from a client perspective.

The network request operation includes appropriate timeout handling to detect unresponsive targets efficiently. The timeout duration is typically configured based on expected network characteristics and service response times, balancing the need for quick detection of unavailable targets against the risk of false negatives due to transient network conditions or temporary service delays. In some implementations, the method can employ adaptive timeout values that adjust based on historical response patterns or network conditions.

Following the network request, the method reaches step 308, which can determine whether the request to the SRV target timed out. This step can represent the determination of target health status based on its response (or lack thereof) to the network request. A timeout can indicate that the target is either unreachable or unresponsive, suggesting that it would be unsuitable for client connections.

If the request timed out, the method proceeds to step 310, where the method can update the internal state representation of the SRV target to mark it as unreachable. This state update can reflect the target's current unavailability and will be used in subsequent operations to adjust its priority in the DNS records. The unreachable state can include additional metadata such as the timestamp of the detection and potentially a counter tracking consecutive failures, which can be useful for implementing more recovery strategies or for administrative monitoring and alerting purposes.

Alternatively, if the request did not time out and received a proper response, the method can proceed to step 312, where the method updates the internal state representation of the SRV target to mark it as reachable. This state update can confirm the target's current availability and can ensure that it will maintain its original priority in the DNS records. Similar to the unreachable state, the reachable state can include metadata such as response times or other performance metrics collected during the health check, enabling more prioritization strategies in advanced implementations.

For targets marked as reachable, the method continues to step 314, where the method can reset the priority and/or weight values for the target to their original configured values. This operation is particularly useful for targets that were previously marked as unreachable but have now recovered, as it ensures that they are restored to their intended position in the service hierarchy. The method can maintain a record of the original priority and weight values for each target, allowing for this automatic restoration upon recovery without requiring administrative intervention.

Following either the unreachable state update in step 310 or the priority reset in step 314, the method converges at step 316, which determines whether there are additional SRV targets left to check in the current cycle. This step allows for iterative processing of all targets associated with the SRV record being monitored.

If there are additional targets to check, the method returns to step 304, selecting the next SRV target for health assessment. This creates a loop that continues until all targets have been evaluated, ensuring comprehensive monitoring of the entire service infrastructure.

Once all targets have been checked, the method proceeds to step 318, where the method can perform an adjustment of priorities and weights across the entire SRV target list. This operation can take the individual target states determined during the current health check cycle and calculate appropriate priority values for each target to reflect their current health status.

In one implementation, this adjustment typically involves assigning very high priority values (e.g., 65535) to targets marked as unreachable, effectively positioning them at the lowest preference level from a client selection perspective. Conversely, targets marked as reachable maintain their original priority values, preserving their intended position in the service hierarchy. This binary approach creates a clear separation between reachable and unreachable targets, ensuring that clients are directed away from unavailable services without disrupting the intended prioritization among available targets.

In more implementations, the priority adjustment operation can incorporate additional factors beyond simple reachability, such as response times, historical reliability, or load metrics collected during the health check or from external monitoring systems. These additional factors can enable more nuanced prioritization strategies, potentially distributing client traffic more evenly among available targets or directing clients preferentially to targets offering superior performance.

After calculating the adjusted priorities and weights, the method proceeds to step 320, where the method can issue an update to the DNS server to modify the SRV records with the new values. This operation typically uses standard DNS update protocols to communicate the changes to the authoritative DNS server, ensuring that subsequent client requests will receive the updated priority information.

The DNS update operation can include appropriate error handling and verification to ensure that the changes are successfully applied. In some implementations, the method can include retry logic to handle temporary DNS server unavailability or verification checks to confirm that the updates were correctly applied. These mechanisms ensure the reliability of the priority adjustment process even in the face of network issues or server problems.

Following the successful update of the DNS records, the method ends, completing the current health check cycle. In some implementations, the method can be triggered again at the next scheduled interval, maintaining ongoing monitoring of target health and continuous adjustment of DNS priorities to reflect current service availability.

This health check method, as illustrated in FIG. 3, enables the dynamic DNS service record management system to provide robust, transparent service reliability enhancement without requiring client-side modifications. By continuously monitoring SRV targets and dynamically adjusting their priorities in the DNS records, the method ensures that clients are naturally directed to available services using the standard DNS priority-based selection mechanism.

The primary advantages of this approach include its compatibility with existing DNS clients, its ability to provide immediate redirection upon target failure, and its support for automatic recovery when previously unavailable targets become operational again. These characteristics make the method particularly valuable in dynamic network environments where service targets can experience transient failures or varying load conditions.

Furthermore, the method illustrated in FIG. 3 provides a foundation that can be extended to support more service targeting strategies beyond simple availability, potentially incorporating performance metrics, load balancing considerations, or application-specific factors to optimize client connection distribution across the service infrastructure.

FIG. 4 is a flowchart illustrating an enhanced load-based health check process for updating SRV priorities or weights according to some embodiments of the disclosure.

In step 402, the method includes triggering a load-based health check cycle for a specific SRV record. Similar to the basic health check method of FIG. 3, this triggering event can occur at regular intervals defined relative to the TTL value of the SRV records being monitored, such as at half the TTL time. This periodic execution can ensure that the method can maintain current information about target performance without creating excessive overhead. In some implementations, the health check can also be triggered by external events, such as notifications from monitoring systems indicating potential performance issues or manual administrative commands requesting immediate load assessment.

Following the initiation of the health check cycle, the method proceeds to step 404, in which the method can select a specific SRV target for load assessment. This selection is typically performed sequentially, processing each target associated with the SRV record being monitored. The selection operation can maintain a reference to the current target being checked and retrieves the necessary identification information to query load metrics for that target. Unlike the health check method of FIG. 3, which directly tests connectivity to each target, this load-based method can interact with a dedicated load monitoring component that aggregates performance metrics across the service infrastructure.

After selecting a target, the method proceeds to step 406, which can include issuing a network request to the load manager component. In this step, instead of directly testing connectivity to each SRV target (as in FIG. 3), the method can query a centralized load monitoring service that continuously collects performance metrics from all targets. In some implementations, however, the load monitoring can be performed directly from the health check server to the SRV targets, bypassing the load monitoring service. This approach provides several advantages, including more comprehensive performance data collection, reduced load from health checking activities themselves, and the ability to consider historical performance trends rather than just point-in-time measurements.

The request to the load manager can include the identifier for the specific SRV target being evaluated, allowing the load manager to return the relevant performance metrics for that target. These metrics can include various indicators of target performance and capacity, such as CPU utilization, memory usage, network bandwidth consumption, request queue length, average response time, error rates, or application-specific performance indicators. The specific metrics collected depend on the nature of the services being provided and the implementation details of the load monitoring infrastructure.

Following the request to the load manager, the method proceeds to step 408, which can include receiving and storing the load data for the current SRV target. This operation processes the response from the load manager, extracting the relevant performance metrics and storing them in the system's internal state representation. The stored data typically includes not only the raw metrics but also derived indicators that can be used for priority calculations, such as normalized load scores or performance ratios relative to configured baselines or to other targets in the same service group.

In some implementations, this operation can also include validation and preprocessing of the received metrics, such as filtering out anomalous values, applying smoothing algorithms to reduce the impact of transient spikes, or calculating trend indicators based on historical data. These preprocessing steps help ensure that the priority adjustments reflect meaningful performance patterns rather than temporary fluctuations or measurement artifacts.

After storing the load data for the current target, the method proceeds to step 410, which can include determining whether there are additional SRV targets left to check in the current cycle. This step enables the iterative processing of all targets associated with the SRV record being monitored, ensuring comprehensive performance assessment across the entire service infrastructure.

If there are additional targets to check, the method proceeds to step 404, selecting the next SRV target for load assessment. This creates a loop that continues until load metrics have been collected for all targets, building a complete performance profile of the service infrastructure.

Once all targets have been assessed, the method proceeds to step 412, which performs a holistic adjustment of priorities and weights across the entire SRV target list based on the collected load metrics. This operation represents the core intelligence of the load-based health check process, translating raw performance metrics into meaningful priority adjustments that will direct client connections optimally across the available targets.

In this embodiment, the priority adjustment typically involves a more nuanced calculation than the binary reachable/unreachable determination used in the basic health check process. The method evaluates the collected load metrics for each target and calculates a composite load score that represents the target's current performance capacity. This score is then mapped to an appropriate priority value, with higher-loaded targets receiving numerically higher priority values (indicating lower preference) and lower-loaded targets receiving numerically lower priority values (indicating higher preference).

This mapping process typically involves several configurable parameters, such as load thresholds that define acceptable performance ranges, weighting factors for different metrics to reflect their relative importance, and smoothing factors to prevent excessive priority fluctuations due to minor load variations. These configuration options allow the method to be tailored to specific service requirements and operational priorities, such as maximizing throughput, minimizing response time, or ensuring equitable resource utilization across the infrastructure.

In addition to load-based prioritization, this operation can also incorporate the basic reachability check from one implementation, ensuring that completely unreachable targets are assigned the lowest priority regardless of their reported load metrics. This hybrid approach combines the benefits of both the basic connectivity check and the enhanced load-based assessment, providing robust failover for unavailable targets while optimizing connection distribution among available ones.

After calculating the adjusted priorities and weights based on load metrics, the method proceeds to step 414, which issues an update to the DNS server to modify the SRV records with the new values. This operation can use standard DNS update protocols to communicate the changes to the authoritative DNS server, ensuring that subsequent client requests will receive the updated priority information that reflects current target performance capacities.

Similar to the basic health check process, the DNS update operation includes appropriate error handling and verification to ensure that the changes are successfully applied. This includes retry logic for temporary DNS server unavailability, verification checks to confirm successful updates, and potentially rollback mechanisms to restore previous values if the update fails. These safeguards ensure the reliability of the priority adjustment process even in challenging network conditions.

Following the successful update of the DNS records, the method can end, completing the current load-based health check cycle. The method will be triggered again at the next scheduled interval, maintaining ongoing monitoring of target performance and continuous adjustment of DNS priorities to optimize client connection distribution.

The load-based health check method illustrated in FIG. 4 represents a significant enhancement over the basic connectivity-focused method shown in FIG. 3. While the basic method provides essential failover capability by directing clients away from unreachable targets, this enhanced method adds load distribution capabilities, optimizing client connections across available targets based on their current performance metrics. This capability is particularly valuable in high-traffic environments where service targets can experience varying load levels that affect their performance even when they remain technically reachable.

By incorporating load metrics into the priority adjustment process, the method can achieve several advanced objectives beyond simple availability assurance. These include load balancing across the service infrastructure, preferential routing to high-performance targets, gradual target drain-down during planned maintenance, and adaptive response to changing traffic patterns or resource constraints. These capabilities enable more efficient resource utilization and improved service quality compared to traditional static prioritization approaches.

Furthermore, the centralized load monitoring architecture depicted in this method offers operational advantages compared to direct target testing. By aggregating performance data collection in a dedicated component, the method can implement more monitoring techniques, reduce the overhead of health checking activities themselves, and potentially incorporate external data sources or historical performance trends into the prioritization decisions. This architectural approach also provides a clear separation of concerns between health assessment and priority management, facilitating system evolution and maintenance.

The load-based health check method illustrated in FIG. 4 demonstrates how the basic dynamic DNS priority adjustment mechanism can be extended to address complex service management challenges beyond simple availability. By incorporating performance metrics into the prioritization process, the method can optimize client connection distribution while maintaining full compatibility with standard DNS clients and protocols. This enhanced capability enables more service management without requiring client-side modifications or protocol extensions, preserving the core benefit of transparent operation across the existing client base.

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 can comprise a general-purpose CPU. The CPU 502 can comprise a single-core or multiple-core CPU. The CPU 502 can comprise a system-on-a-chip (SoC) or a similar embedded system. In some embodiments, a graphics processing unit (GPU) can be used in place of, or in combination with, a CPU 502. Memory 504 can comprise a memory system including a dynamic random-access memory (DRAM), static random-access memory (SRAM), Flash (e.g., NAND Flash), or combinations thereof. In one embodiment, the bus 514 can comprise a Peripheral Component Interconnect Express (PCIe) bus. In some embodiments, the bus 514 can comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 can include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 can then read the software or data from RAM 506, process them, and store them in RAM 506 again.

The device can optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface can be coupled to a speaker and microphone (not shown) to enable telecommunication with others or generate an audio acknowledgment for some action. Displays in peripheral devices 512 can comprise liquid crystal display (LCD), gas plasma, light-emitting diode (LED), or any other type of display device used with a computing device. A display can also include a touch-sensitive screen arranged to receive input from an object such as a stylus or a digit from a human hand.

A keypad in peripheral devices 512 can comprise any input device arranged to receive input from a user. An illuminator in peripheral devices 512 can provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device can communicate through other components, providing other information that can be employed to determine the physical location of the device, including, for example, a media access control (MAC) address, Internet Protocol (IP) address, or the like.

The device can include more or fewer components than those shown, depending on the deployment or usage of the device. For example, a server computing device, such as a rack-mounted server, can not include audio interfaces, displays, keypads, illuminators, haptic interfaces, Global Positioning System (GPS) receivers, or cameras/sensors. Some devices can include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter can be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms can have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology can be understood at least in part from usage in context. For example, terms, such as “and,” “or,” or “and/or,” as used herein can include a variety of meanings that can depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
monitoring, by a processor, a plurality of SRV targets referenced in SRV records to determine availability status;
performing, by the processor, health checks on each of the plurality of SRV targets using protocol information specified in the SRV records;
determining, by the processor, whether each of the plurality of SRV targets is reachable based on responses to the health checks;
adjusting, by the processor, priority values in the SRV records, the priority values for unreachable targets set to a lower preference level than priority values for reachable targets; and
updating, by the processor, the SRV records in an authoritative DNS server with the priority values.

2. The method of claim 1, wherein performing health checks comprises sending connection requests to each SRV target at intervals determined based on Time to Live (TTL) values of the SRV records.

3. The method of claim 1, wherein adjusting priority values comprises:
setting a priority value for an unreachable SRV target to a numerical value; and
maintaining original priority values for reachable SRV targets.

4. The method of claim 1, further comprising:
storing, by the processor, original priority values for each of the plurality of SRV targets; and
restoring, by the processor, an original priority value for a previously unreachable SRV target when the previously unreachable SRV target becomes reachable again.

5. The method of claim 1, further comprising:
collecting, by the processor, load metrics from the plurality of SRV targets;
calculating, by the processor, load scores for each of the plurality of SRV targets based on the load metrics; and
adjusting, by the processor, the priority values in the SRV records based on the load scores and whether each of the plurality of SRV targets is reachable.

6. The method of claim 5, wherein the load metrics include one or more of processor utilization, memory usage, network bandwidth consumption, request queue length, response time, or error rates.

7. The method of claim 1, wherein determining whether each of the plurality of SRV targets is reachable comprises:
issuing a network request to each SRV target using protocol and port information specified in a corresponding SRV record;
monitoring for a response from each SRV target for a configured timeout period; and
marking a SRV target as unreachable if no response is received within the configured timeout period.

8. A non-transitory computer-readable storage medium for tangibly storing computer program instructions capable of being executed by a processor, the computer program instructions defining steps of:
monitoring, by the processor, a plurality of SRV targets referenced in SRV records to determine availability status;
performing, by the processor, health checks on each of the plurality of SRV targets using protocol information specified in the SRV records;
determining, by the processor, whether each of the plurality of SRV targets is reachable based on responses to the health checks;
adjusting, by the processor, priority values in the SRV records, the priority values for unreachable targets set to a lower preference level than priority values for reachable targets; and
updating, by the processor, the SRV records in an authoritative DNS server with the priority values.

9. The non-transitory computer-readable storage medium of claim 8, wherein performing health checks comprises sending connection requests to each SRV target at intervals determined based on Time to Live (TTL) values of the SRV records.

10. The non-transitory computer-readable storage medium of claim 8, wherein adjusting priority values comprises:
setting a priority value for an unreachable SRV target to a numerical value; and
maintaining original priority values for reachable SRV targets.

11. The non-transitory computer-readable storage medium of claim 8, the steps further comprising:
storing, by the processor, original priority values for each of the plurality of SRV targets; and
restoring, by the processor, an original priority value for a previously unreachable SRV target when the previously unreachable SRV target becomes reachable again.

12. The non-transitory computer-readable storage medium of claim 8, the steps further comprising:
collecting, by the processor, load metrics from the plurality of SRV targets;
calculating, by the processor, load scores for each of the plurality of SRV targets based on the load metrics; and
adjusting, by the processor, the priority values in the SRV records based on the load scores and whether each of the plurality of SRV targets is reachable.

13. The non-transitory computer-readable storage medium of claim 12, wherein the load metrics include one or more of processor utilization, memory usage, network bandwidth consumption, request queue length, response time, or error rates.

14. The non-transitory computer-readable storage medium of claim 8, wherein determining whether each of the plurality of SRV targets is reachable comprises:
issuing a network request to each SRV target using protocol and port information specified in a corresponding SRV record;
monitoring for a response from each SRV target for a configured timeout period; and
marking a SRV target as unreachable if no response is received within the configured timeout period.

15. A device comprising:
a processor configured to:
monitor a plurality of SRV targets referenced in SRV records to determine availability status;
perform health checks on each of the plurality of SRV targets using protocol information specified in the SRV records;
determine whether each of the plurality of SRV targets is reachable based on responses to the health checks;
adjust priority values in the SRV records, the priority values for unreachable targets set to a lower preference level than priority values for reachable targets; and
update the SRV records in an authoritative DNS server with the priority values.

16. The device of claim 15, wherein performing health checks comprises sending connection requests to each SRV target at intervals determined based on Time to Live (TTL) values of the SRV records.

17. The device of claim 15, wherein adjusting priority values comprises:
setting a priority value for an unreachable SRV target to a numerical value; and
maintaining original priority values for reachable SRV targets.

18. The device of claim 15, the processor further configured to:
store original priority values for each of the plurality of SRV targets; and
restore an original priority value for a previously unreachable SRV target when the previously unreachable SRV target becomes reachable again.

19. The device of claim 15, the processor further configured to:
collect load metrics from the plurality of SRV targets;
calculate load scores for each of the plurality of SRV targets based on the load metrics; and
adjust the priority values in the SRV records based on the load scores and whether each of the plurality of SRV targets is reachable.

20. The device of claim 15, wherein determining whether each of the plurality of SRV targets is reachable comprises:
issuing a network request to each SRV target using protocol and port information specified in a corresponding SRV record;
monitoring for a response from each SRV target for a configured timeout period; and
marking a SRV target as unreachable if no response is received within the configured timeout period.
